(19) United States
(12) Patent Application Publication
(10) Pub. No.: US 2011/0270618 A1
(43) Pub. Date: Nov. 3, 2011

(54) MOBILE COMMERCE SYSTEM

(75) Inventors: Sudeshna Banerjee, Waxhaw, NC (US); Thayer S. Allison, JR., Charlotte, NC (US); Debashis Ghosh, Charlotte, NC (US); David Joa, Irvine, CA (US); Kurt D. Newman, Matthews, NC (US); Hemant Kagade, Charlotte, NC (US); Yanghong Shao, Charlotte, NC (US)

(73) Assignee: BANK OF AMERICA CORPORATION, Charlotte, NC (US)

(21) Appl. No.: 12/770,947

(22) Filed: Apr. 30, 2010

(51) Int. Cl. G06Q 30/00; G01S 19/51

(52) U.S. Cl. 705/1.1; 342/357.34

(57) ABSTRACT

Embodiments of the invention are directed to systems, methods, and computer program products for providing targeted product offers to a consumer's mobile device based on the consumer's current location, location history, transaction history, and purchase thresholds. Embodiments of the invention are also directed to systems, methods, and computer program products for obtaining feedback from the consumer in relation to an offer and providing a modified offer based on the feedback. In one embodiment, the feedback is a determination that a consumer is not interested in a merchant offer based on the consumer's substantially real-time location information and transaction information.

### FIELD

In general, embodiments of the invention relate to methods, apparatuses, and computer program products for providing an interactive mobile commerce system.

### BACKGROUND

The advent of the Internet has provided merchants with new channels for reaching customers and providing information, advertising, and offers related to their products or services. However, sales and marketing campaigns are often not as effective as they might otherwise be, because they provide the customer with the wrong information, advertisements, or offers, or alternatively provide the customer with the right information, advertisements, or offers at the wrong time. The Internet, likewise, provides customers with the ability to quickly locate information about products or services in which they are interested, and to purchase those products or services, without leaving their computer. Similarly, with the advent of data access cellular plans and sophisticated smart phones, customers have an opportunity to access purchase information on the fly. However, customers who shop online, either at a computer or via a cellular phone, often cannot find the exact product or service that they want, fail to find what they want at a price that they find attractive, or fail to utilize discounts that are available for the products and services. These scenarios result in promotions offered by the merchant not being utilized or in customers not receiving the benefit of such promotions. Therefore, systems and methods are needed to provide, and improve upon, the relationships outlined above between consumers and merchants.

### BRIEF SUMMARY

Embodiments of the present invention address these and/or other needs by providing an innovative mobile commerce system. The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

In one embodiment of the mobile commerce system, a consumer's location relative to one or more merchants is tracked using, for example, a location determining system of the consumer's cell phone or other mobile device. The mobile commerce system correlates the consumer's location relative to the one or more merchants along with the consumer's transactions to determine trends in the consumer's shopping behavior. These trends are then used to provide certain services to the consumer via the consumer's mobile device. Such services include providing electronic coupons, discounts, advertisements, brochures, offers, and/or other information that is targeted or customized for the consumer based on the consumer's location and location-based transaction trends.

In some embodiments, the mobile commerce system is further configured to receive input from the consumer and then provide targeted or customized product offers based on the consumer's input. For example, in one embodiment of the invention the consumer uses a mobile device to enter certain shopping specifications for a particular product or type of product, where the shopping specifications represent the aspects of an offer that a consumer is looking for when deciding whether to purchase the particular product or type of product. Such thresholds may include, for example, maximum price, price range, distance from the consumer's current location, performance requirements, features, discounts, add-on products, service plans, warranties, location, inventory status (e.g., in stock, temporarily out of stock), delivery options, date, time, merchant, brand, and/or the like. In another example of consumer input, some embodiments of the mobile commerce system provide the consumer with a survey that asks the consumer why he or she did not accept a particular offer. This survey provides the merchant with useful marketing information and may also provide the merchant with an opportunity to quickly provide another offer to the consumer based on the survey.

Furthermore, some embodiments of the invention use information received from the consumer's mobile phone to determine that a consumer is not interested in a merchant or merchant's offer and then responds with a survey and/or modified offer from the merchant. For example, in one embodiment of the invention, the mobile commerce system is configured to identify in real time or near real time when a consumer is leaving a particular merchant's location. The mobile commerce system can then quickly notify the merchant and allow the merchant to respond with a targeted communication, such as a better offer or a survey, thereby providing the merchant with another opportunity to close the sale before the consumer leaves the merchant's location.

For example, some embodiments of the invention provide a computer-implemented method, the method involving: (1) receiving location information for a consumer's mobile device; (2) using the location information to determine the consumer's location relative to a merchant; (3) providing an offer to the consumer's mobile device based at least partially on the consumer's location relative to the merchant; (4) determining that the consumer lacks interest in the offer; and (5) communicating with the consumer's mobile device about the offer based at least partially on the determining that the consumer lacks interest in the offer. In some such embodiments, communicating further with the consumer's mobile device about the offer involves providing a survey to the consumer's mobile device, the survey comprising one or more questions inquiring about the consumer's reaction to the offer. In some such embodiments, the method the communicating further with the consumer's mobile device about the offer further involves providing a modified offer to the consumer's mobile device based at least partially on a response to the survey. In some embodiments, the one or more questions include one or more questions inquiring about why the consumer lacks interest in the offer. In some embodiments of the method, communicating further with the consumer's mobile device about the offer involves providing the consumer's mobile device with a modified offer related to the first offer.

In some embodiments of the method, determining that the consumer lacks interest in the offer includes using the location information to determine that the consumer is leaving the merchant. In some embodiments, determining that the consumer lacks interest in the offer includes determining that the consumer has not accepted the offer after a predefined period of time. In some embodiments, determining that the consumer lacks interest in the offer includes receiving from the consumer's mobile device an affirmative rejection of the offer. In some embodiments, determining that the consumer lacks interest in the offer includes determining that the consumer purchased a competing product competitive with a product associated with the offer. In some embodiments, determining that the consumer lacks interest in the offer includes identifying a trend in the consumer's transaction history.

In some embodiments of the invention, the method further includes: receiving one or more purchase thresholds specified by the consumer; and providing the offer to the consumer's mobile device based at least partially on the one or more purchase thresholds. For example, the one or more purchase thresholds may include a maximum price or a maximum distance from the consumer's current location.

In some embodiments of the method, receiving location information for the consumer's mobile device includes receiving information about interaction with the consumer's mobile device and a sensor or transceiver located proximate the merchant. In other embodiments of the method, receiving location information for the consumer's mobile device includes receiving location information from a global positioning system.

Embodiments of the invention also provide an apparatus having: (1) a positioning system configured for determine location information for a consumer's mobile device; (2) a computer system configured to use the location information to determine the consumer's location relative to a merchant; (3) a computer system configured to provide an offer to the consumer's mobile device based at least partially on the consumer's location relative to the merchant; (4) a computer system configured to determine that the consumer lacks interest in the offer; and (5) a communication system configured to communicate with the consumer's mobile device about the offer based at least partially on the determining that the consumer lacks interest in the offer. In some embodiments, the computer system is configured to determine that the consumer lacks interest in the offer is configured to determine that the consumer lacks interest in the offer based at least in part on the location information.

Embodiments of the invention also provide an apparatus having: (1) a communication interface configured to receive information from a mobile device; and (2) a processor configured to: (A) determine that a consumer associated with the mobile device lacks interest in an offer provided by the merchant, the determination based at least partially on the information received from the mobile device; and (B) use the communication interface to communicate with the mobile device about the offer based at least partially on the determination that the consumer lacks interest in the offer.

Embodiments of the invention also provide an apparatus having: (1) a memory comprising financial transaction information stored therein for a plurality of consumers; (2) a positioning system configured to receive location information about a mobile device associated with a consumer of the plurality of consumers; (3) a communication device configured to communicate with the mobile device; and (4) a processor communicably coupled to the communication device, the positioning system, and the memory and configured to: (A) determine from the financial transaction information and the location information a percentage of consumer visits to a merchant that are associated with a transaction; and (B) provide information to the mobile device or the merchant based at least in part on the percentage of consumer visits to the merchant that are associated with a transaction. In one embodiment, the processor is configured to provide a survey to the mobile device based at least in part on the percentage of consumer visits to the merchant that are associated with a transaction. In some embodiments, the processor is configured to use the communication device to receive survey results from the mobile device and provide the survey results to the merchant. In some embodiments, the processor is configured to provide an offer from the merchant to the mobile device based at least in part on the percentage of consumer visits to the merchant that are associated with a transaction. In some embodiments, the processor is configured to provide information to the mobile device or the merchant based on whether the percentage is beyond a predefined threshold value.

Embodiments of the invention also provide an apparatus having: (1) a memory; (2) a communication device; and (3) a processor operatively coupled to the memory and the communication device. In some embodiments, the processor is configured to execute non-transitory computer-readable program code to: (A) receive information related to a physical location of a consumer; (B) access consumer transaction information from the consumer's account at a financial institution; (C) determine an offer for the consumer based at least in part on the physical location of the consumer and the consumer transaction information from the consumer's account at the financial institution; and (D) provide the consumer the offer on a consumer mobile device. In some embodiments, the processor is further configured to receive purchase thresholds from the consumer and determine an offer for the consumer based at least in part on the purchase thresholds received from the consumer.

Embodiments of the invention also provide a computer program product for a mobile commerce system, the computer program product comprising at least one non-transitory computer-readable medium having computer-executable program code portions embodied therein, the computer-executable program code portions comprising: (1) an executable portion configured for receiving information related to a physical location of a consumer; (2) an executable portion configured for accessing consumer transaction information from the consumer's account at a financial institution; (3) an executable portion configured for determining an offer for the consumer based at least in part on the physical location of the consumer and the consumer transaction information from the consumer's account at the financial institution; and (4) an executable portion configured for providing the consumer the offer on a consumer mobile device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a mobile commerce system and environment in accordance with an embodiment of the invention;

FIG. 2 provides a block diagram illustrating the consumer mobile device of FIG. 1 in more detail in accordance with an embodiment of the invention;

FIG. 3 provides a block diagram illustrating the financial management system of FIG. 1 in more detail in accordance with an embodiment of the invention;

FIG. 4 provides a block diagram illustrating the merchant system of FIG. 1 in more detail in accordance with an embodiment of the invention;

FIG. 5 provides a block diagram illustrating the mobile commerce system of FIG. 1 in more detail in accordance with an embodiment of the invention;

FIG. 6 provides a flow chart illustrating an interactive mobile commerce process in accordance with an embodiment of the invention;

FIG. 7 provides a flow chart illustrating an interactive feature of a mobile commerce process in accordance with an embodiment of the invention;

FIG. 8 provides a flow chart illustrating one example embodiment of the process of FIG. 7 where consumer interest in an offer is determined and surveys and/or modified offers are provided based on the interest determination;

FIG. 9 provides a flow chart illustrating another example embodiment of the process of FIG. 7 where consumer interest in an offer is determined based on mobile device location information and surveys and/or modified offers are provided based on the interest determination;

FIG. 10 provides a flow chart illustrating yet another example embodiment of the process of FIG. 7 where systematic consumer lack of interest in a merchant is determined based on mobile device location information and financial transaction information, and surveys and/or modified offers are provided based on the determination of systematic lack of interest;

FIG. 11 provides example consumer-specified shopping specifications and an example mobile offer interface in accordance with an embodiment of the invention; and

FIG. 12 provides an example mobile survey and survey interface, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

The inventors of embodiments of the present invention have recognized that financial institutions have access to large amounts of consumer data because they maintain or administer their customers' various financial accounts (i.e. credit card accounts, checking accounts, savings accounts, etc.) and because they also have data related to their customers' purchases. Financial institutions track and store data related to the goods or services (i.e., “products”) that customers purchase, when their customers make their purchases, where the customers make their purchases, how much the customers spend, and/or the like, both for online and offline purchases. Furthermore, financial institutions also have direct ties with many different merchants that use the financial institutions for their own financial needs. Due to the relationships financial institutions have with both consumers and merchants, as well as the data that they capture as a result of these relationships, financial institutions are uniquely positioned to facilitate merchants in providing targeted sales and marketing offers to consumers at the time of purchase, and to provide consumers with payment options and information (e.g., balances) for making purchasing decisions for products. As such, embodiments of the present invention provide apparatuses (e.g. systems, computer program products, and/or other devices), methods, or a combination of the foregoing for integrating merchant offers related to products with real time or substantially real time customer shopping activities, location information, and input. These apparatuses, methods, and computer program products also provide timely and relevant feedback to the merchant and customer in order to improve the probability of the success of the distributed offers or other sales opportunities and investments. Some embodiments of the invention use information received from the consumer's mobile phone to determine that a consumer is not interested in a merchant or merchant's offer and then responds with a survey and/or modified offer from the merchant. For example, in one embodiment of the invention, the mobile commerce system is configured to identify in real time or near real time when a consumer is leaving a particular merchant's location. The mobile commerce system can then quickly notify the merchant and allow the merchant to respond with a targeted communication, such as a better offer or a survey, thereby providing the merchant with another opportunity to close the sale before the consumer leaves the merchant's location.

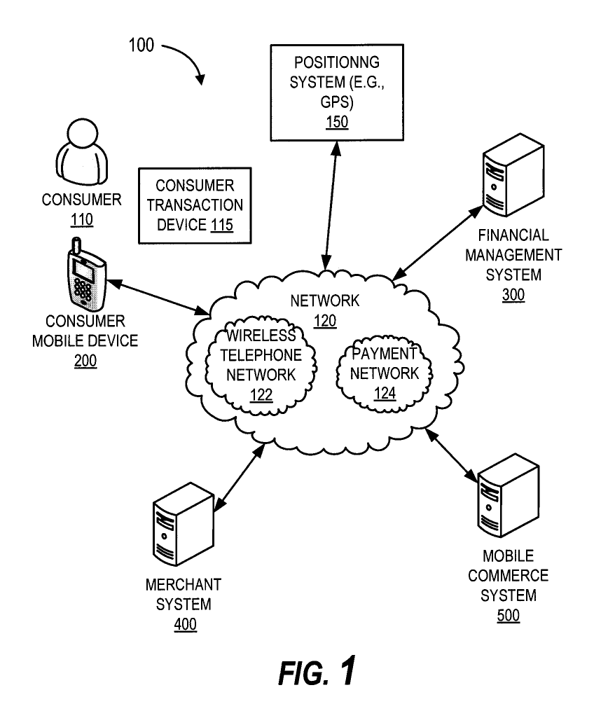

Referring now to the figures, FIG. 1 provides a block diagram illustrating a mobile commerce system and environment 100 in accordance with an embodiment of the invention. As illustrated, the system 100 generally includes a consumer 110. The consumer 110 may be any individual or entity with the potential to purchase products from a merchant. As used herein, the term “products” refers to goods, services, and/or the like. As used herein, the term “merchant” refers to any entity involved in advertising, promoting, offering, creating, manufacturing, selling, or otherwise providing one or more products to one or more consumers. For example, the merchant may be a manufacturer, retailer, wholesaler, advertiser, marketer, distributor, and/or the like.

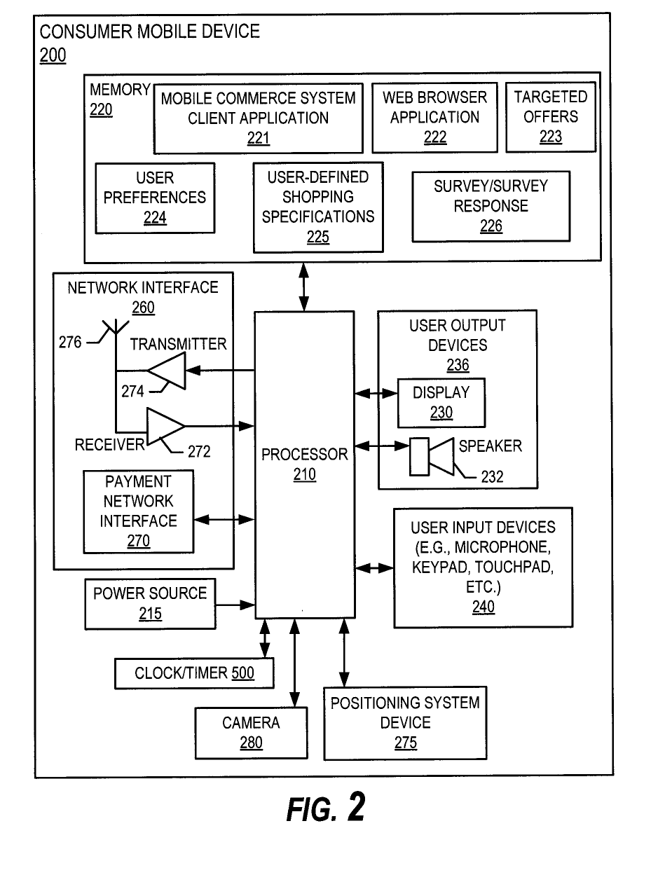

The consumer 110 typically has a mobile device 200, such as a mobile phone, personal digital assistant (PDA), personal navigation device, personal web-surfing device, or other personal/mobile computing device. Embodiments of the consumer mobile device 200 are described in greater detail in FIG. 2 and the accompanying description.

The consumer 110 also generally has a transaction device 115, such as, but not limited to, a bank card (e.g., a bank-issued credit or debit card). The transaction device 115 may be any device that can be used by one or more of the systems described herein to identify a financial account (e.g., a credit account, debit account, demand deposit account, investment account, spending account, and/or the like) associated with the transaction device 115 and/or the consumer 110, thereby, allowing the consumer 110 to use the transaction device 115 to make transactions involving the financial account. In some embodiments, the consumer transaction device 115 and consumer mobile device 200 are combined into a single device. For example, in one embodiment, the consumer's mobile device 200 is equipped with near-field communication (NFC) capabilities that enable it to communicate with merchant point-of-sale (POS) devices so that the mobile device 200 can be used in place of a credit card. In other embodiments, consumer biometrics are used to identify a financial account associated with the consumer 110. As used herein, a “financial transaction” may be, but is not limited to, a purchase, sale, return, withdrawal, deposit, money transfer, account inquiry, and/or the like.

Embodiments of the invention also include a network 120 the network may be any one or more devices or connections communicably coupling two or more devices. For example, the network 120 my include a global area network, such as the Internet, a wide area network, a local area network, a wireless network, a wire-line network, one or more modems, one or more servers, one or more relay devices, one or more direct electrical connections, one or more satellites, and/or the like. As illustrated, in some embodiments, the network 120 includes a wireless telephone network 122, such as a cellular network or other mobile telephone/data network known in the art. As also illustrated, in some embodiments, the network 120 includes a payment network 122 for processing electronic or other payments and transferring money between banks and other entities. For example, the payment network may include the networks of one or more banks or other well-known payment network providers such as Visa®, MasterCard®, American Express®, and/or the like.

Embodiments of the present invention also include a positioning system 150, such as the well-known Global Positioning System (GPS) or other systems for identifying precise geographical locations of individuals or devices, or positions of individuals or devices relative to known objects or locations. For example, some embodiments of the invention include a positioning system that can identify the current latitude and longitude, and in some cases altitude, of the consumer's mobile device 200 using a sensor/transceiver in the consumer's mobile device 200 in conjunction with a satellite system and/or the wireless telephone network 122. In other embodiments, more local sensors/transceivers interact with sensors/transceivers of the consumer's mobile device 200 to determine if the consumer 110 is within a certain distance from a merchant and/or moving toward or away from the merchant. For example, in one embodiment of the invention, a merchant has sensors at its entrances that can communicate with consumer mobile devices 200 that have NFC capabilities and, thereby, determine when a consumer 110 possessing the consumer mobile device 200 enters or leaves the merchant's facility.

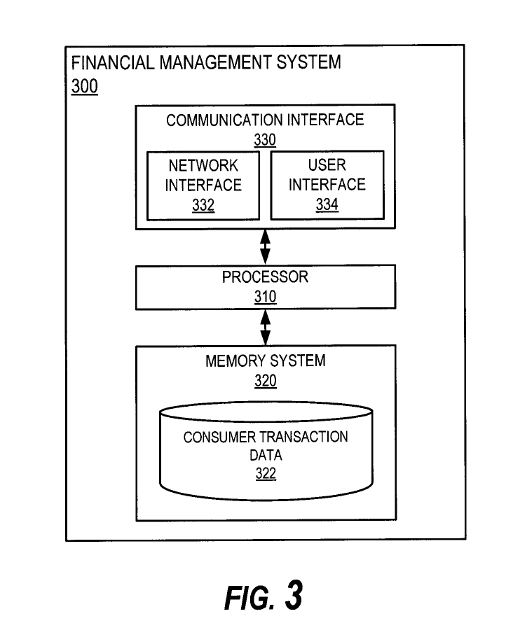

Embodiments of the present invention may also include a financial management system 300. The financial management system 300 stores financial information for the consumer 110 and/or the merchant and processes financial transactions for the consumer and/or the merchant. Embodiments of the financial management system 300 are described in greater detail in FIG. 3 and the accompanying description.

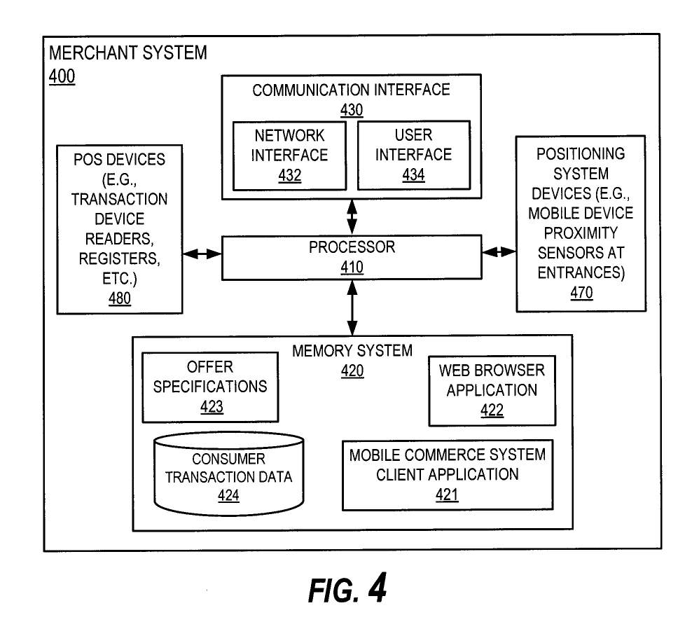

Embodiments of the present invention may also include a merchant system 400. The merchant system 400 processes transactions between the consumer 110 and the merchant and allows the merchant to interact with the mobile commerce system 500. Embodiments of the merchant system 400 are described in greater detail in FIG. 4 and the accompanying description.

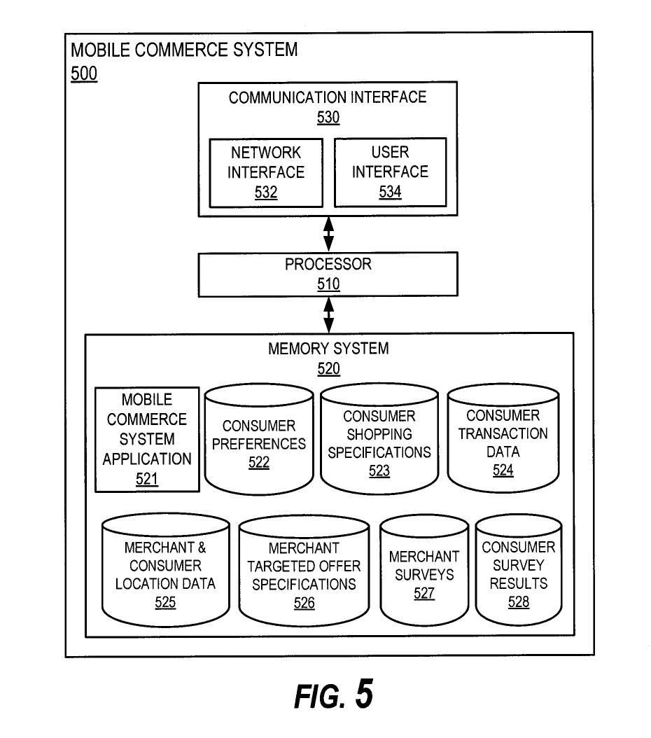

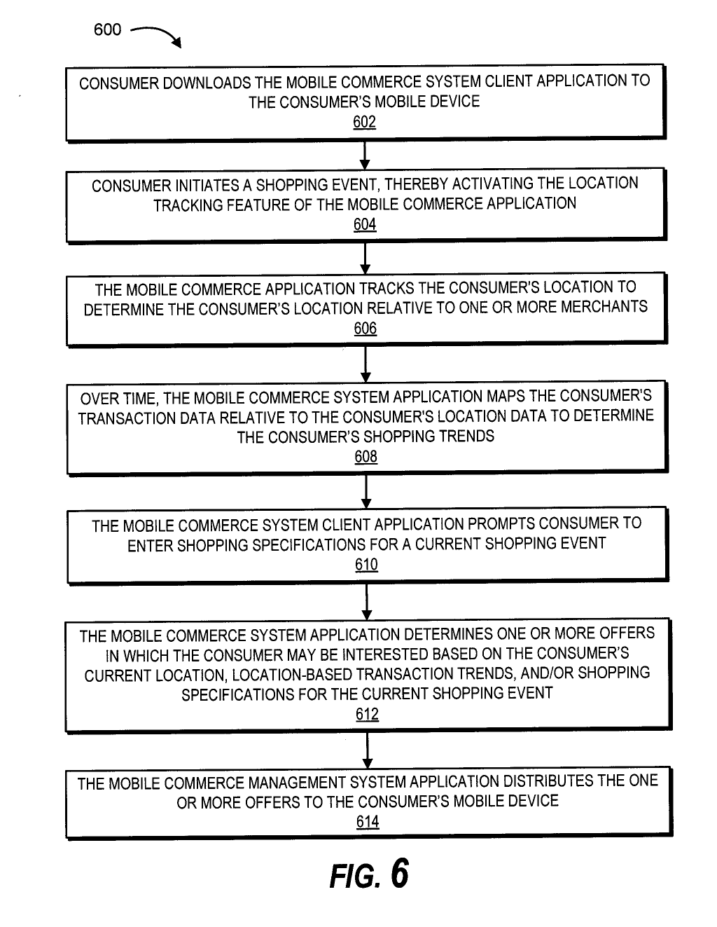

Embodiments of the present invention also include a mobile commerce system 500. The mobile commerce system 500 manages various mobile commerce processes, features, and functions described herein, such as the processes described below in FIGS. 6 through 10 and the accompanying descriptions. Embodiments of the merchant system 500 are described in greater detail in FIG. 5 and the accompanying description.

For example, as described in greater detail below, in one embodiment of the mobile commerce system, a consumer's location relative to one or more merchants is tracked using the positioning system 150 and the consumer's mobile device 200. The mobile commerce system 500 correlates the consumer's location relative to the one or more merchant locations along with the consumer's transactions obtained from the financial management system 300 to determine trends in the consumer's shopping behavior. These trends are then used to provide certain services to the consumer 110 via the consumer's mobile device 200. Such services include providing electronic coupons, discounts, advertisements, brochures, offers, surveys, and/or other information that is targeted or customized for the consumer 110 based on the consumer's location and location-based transaction trends.

In some embodiments, the mobile commerce system 500 is further configured to receive input from the consumer 110, via for example the consumer's mobile device 200, and then provide targeted or customized product offers based on the consumer's input. For example, in one embodiment of the invention, the consumer 110 uses a mobile device 200 to enter certain shopping specifications for a particular product or type of product, where the shopping specifications represent the aspects of an offer that the consumer 110 is looking for when deciding whether to purchase the particular product or type of product. Such thresholds may include, for example, maximum price, price range, distance from the consumer's current location, performance requirements, features, discounts, add-on products, service plans, warranties, location, inventory status (e.g., in stock, temporarily out of stock), delivery options, date, time, merchant, brand, and/or the like. In another example of consumer input, some embodiments of the mobile commerce system 500 provide the consumer 110 with a survey that asks the consumer 110 why he or she did not accept a particular offer. This survey provides the merchant system 400 with useful marketing information and may also provide the merchant system 400 with an opportunity to quickly provide another offer to the consumer based on the survey. In some embodiments of the invention, a survey platform is used such as the survey platform described in co-pending U.S. patent application Ser. No. 12/405,748 filed Mar. 17, 2009, and entitled “Conducting Customized Market Surveys with Transaction Data,” which is assigned to the same assignee as the present application, and which is incorporated herein by reference. In other embodiments, other survey platforms are used.

Furthermore, some embodiments of the invention use information received from the consumer's mobile device 200 to determine that a consumer 110 is not interested in a particular merchant or merchant offer and then responds with a survey and/or modified offer from the merchant system 400. For example, in one embodiment of the invention, the mobile commerce system 500 is configured to identify in real time or near real time when a consumer 110 is leaving a particular merchant's location. The mobile commerce system 500 can then quickly notify the merchant system 400 and allow the merchant system 400 to respond with a targeted communication, such as a better offer or a survey, thereby providing the merchant with another opportunity to close the sale before the consumer 110 leaves the merchant's location.

FIG. 2 provides a block diagram illustrating the consumer mobile device 200 of FIG. 1 in more detail in accordance with an embodiment of the invention. In one embodiment of the invention, the mobile device 200 is a mobile telephone. However, it should be understood, however, that a mobile telephone is merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, mobile televisions, gaming devices, laptop computers, cameras, video recorders, audio/video player, radio, GPS devices, or any combination of the aforementioned.

The mobile device 200 generally includes a processor 210 communicably coupled to such devices as a memory 220, user output devices 236, user input devices 240, a network interface 260, a power source 215, a clock or other timer 500, a camera 280, and a positioning system device 275. The processor 210, and other processors described herein, generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like.

The processor 210 is configured to use the network interface 260 to communicate with one or more other devices on the network 120. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 122. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 200 may also be configured to operate in accordance with non-cellular communication mechanisms, such as via a wireless local area network (WLAN) or other communication/data networks.

The network interface 260 may also include a payment network interface 270. The payment network interface 270 may include software, such as encryption software, and hardware, such as a modem, for communicating information to and/or from one or more devices on a payment network 124. For example, the mobile device 200 may be configured so that it can be used as a credit or debit card by, for example, wirelessly communicating account numbers or other authentication information to a POS terminal of the payment network 124 and/or merchant system 400.

As described above, the mobile device 200 has a user interface that is, like other user interfaces described herein, made up of user output devices 236 and/or user input devices 240. The user output devices 236 include a display 330 (e.g., a liquid crystal display or the like) and a speaker 232 or other audio device, which are operatively coupled to the processor 210. The user input devices 240, which allow the mobile device 200 to receive data from a user such as the consumer 110, may include any of a number of devices allowing the mobile device 200 to receive data from a user, such as a keypad, keyboard, touch-screen, touchpad, microphone, mouse, joystick, other pointer device, button, soft key, and/or other input device(s). The user interface may also include a camera 280, such as a digital camera.

The mobile device 200 also includes a positioning system device 275 that is configured to be used by the positioning system 150 to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a merchant or other location to determine that the consumer mobile device 200 is located proximate these known devices.

The mobile device 200 further includes a power source 215, such as a battery, for powering various circuits and other devices that are used to operate the mobile device 200. Embodiments of the mobile device 200 may also include a clock or other timer 500 configured to determine and, in some cases, communicate actual or relative time to the processor 210 or one or more other devices.

The mobile device 200 also includes a memory 220 operatively coupled to the processor 210. As used herein, memory includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which comprise computer-executable instructions/code executed by the processor 210 to implement the functions of the mobile device 200 described herein. For example, the memory 220 may include such applications as a conventional web browser application 222 and/or a mobile commerce system client application 221. These applications also typically provide a graphical user interface (GUI) on the display 330 that allows the consumer 110 to communicate with the consumer mobile device 200, the mobile commerce system 500, and/or other devices. In one embodiment of the invention, when the consumer 110 decides to enroll in the mobile commerce program, the consumer 110 downloads the mobile commerce system client application 221 from the mobile commerce system 500. In other embodiments of the invention, the consumer 110 interacts with the mobile commerce system 500 via the web browser application 220 in addition to, or instead of, the mobile commerce system client application 221.

The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user preferences information 224, user-defined shopping specifications 225, surveys and/or survey responses 226, and targeted offers 223.

The user preferences information 224 may include, for example, information used by the mobile commerce system 500 to determine the identity of the user, what type of offers the user may be interested in, when the user would like to receive offers, how the user would like to receive offers, when the user would like for the user's location to be available to the mobile commerce system 500, and/or the like. The user preference information 224 may be requested, for example, by the mobile commerce system client application 221 via the user output devices 236, and may be entered by the consumer 110 via the user input devices 240 and then stored by the processor 210 in the memory 220 and, in some cases, communicated to the mobile commerce system 500 via the network interface 260. In some embodiments, the user preferences include a digital certificate or other file used by the mobile commerce system 500 to identify and/or authenticate the consumer 110 associated with the mobile device 200 in a secure and/or encrypted way. Some examples of user preferences 224 are described in greater detail below with reference to the flow charts.

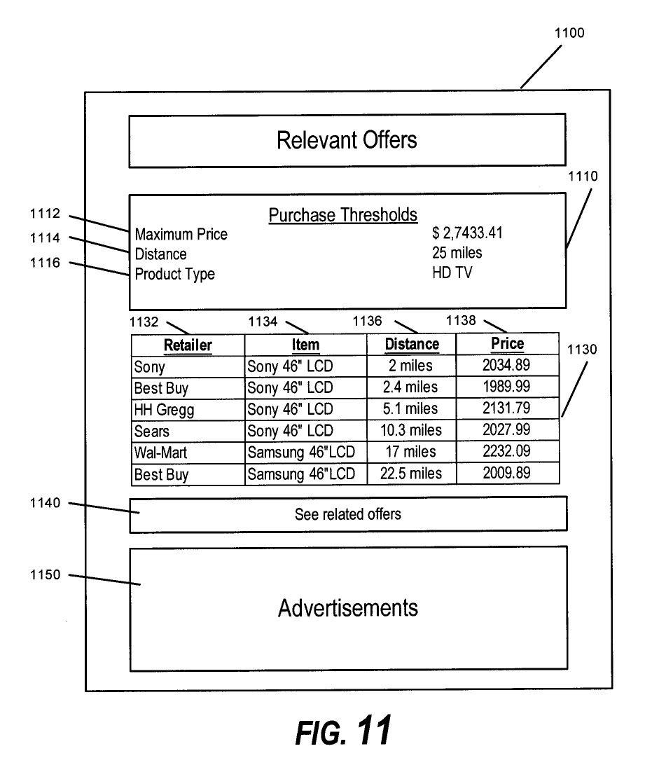

The user-defined shopping specifications 225 may include, for example, information about a user's current or future shopping event and may include such information as the product or type of product that the consumer 110 is in the market for, where the consumer 110 is currently shopping or plans to shop (e.g., geographic area, store name, and/or the like), when the consumer 110 plans to shop, the consumer's budget or budget range, and/or the like. The user-defined shopping specifications 225 may also include one or more user-defined purchase thresholds such as, for example, a maximum price that the consumer 110 is willing to spend on a product or product type, a maximum distance the consumer 110 is willing to travel from the consumer's current location or a specified location to purchase the product, and/or the like. The user-defined shopping specifications 225 may be requested, for example, by the mobile commerce system client application 221 via the user output devices 236, and may be entered by the consumer 110 via the user input devices 240 and then stored by the processor 210 in the memory 220 and, in some cases, communicated to the mobile commerce system 500 via the network interface 260. Some examples of user-defined shopping specifications 225 are described in greater detail throughout this disclosure and, in particular, with reference to the flow charts and FIG. 11.

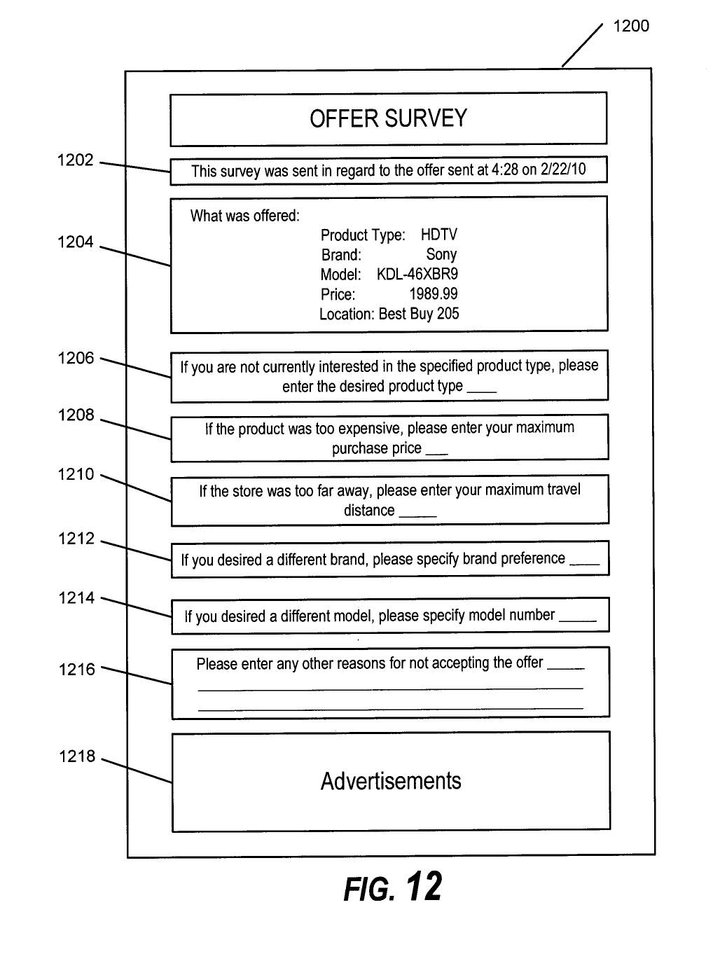

The surveys and/or survey responses 226 may include one or more surveys received from the mobile commerce system 500 that are at least temporarily stored in the memory 220 of the consumer mobile device 200. If the consumer 110 chooses to respond to the surveys by, for example, answering the one or more questions contained therein, the consumer's responses are at least temporarily stored in the memory 220 until they are communicated, via the network interface 260, to the mobile commerce system 500. In one embodiment of the invention, the surveys ask the consumer 110 for reasons why an offer was rejected. Some examples of the surveys and/or survey responses 226 are described in greater detail herein with reference to the flow charts and FIG. 12.

The targeted offers 223 are customized (e.g., personalized or targeted) offers from one or more merchants to the consumer 110. These offers 223 may include advertisements, discounts, promotions, coupons, and/or the like and are communicated from the mobile commerce system 500 to the consumer mobile device 200 via the network interface 260. The offers 223 are then at least temporarily stored in the memory 220 and presented to the consumer 110 by the mobile commerce system client application 221 and/or web browser application 222 using one or more of the user output devices 236. Some examples of targeted offers 223 are described in greater detail herein with reference to the flow charts and FIG. 11.

FIG. 3 provides a block diagram illustrating the financial management system 300 of FIG. 1 in more detail in accordance with an embodiment of the invention. The financial management system 300 generally includes a processor 310 communicably coupled to a communication interface 330 and a memory system 320. Like the processor 210 described with respect to FIG. 2, the processor 310 comprises the circuitry and logic to perform the various functions of the financial management system 300 described herein. The communication interface 330 includes a network interface 332 and a user interface 334, which may be similar to those described above with respect to FIG. 2. The memory system 320 includes consumer transaction data 322 stored therein. The consumer transaction data 322 includes information about one or more consumer transactions, such as transaction amount, time, location, merchant, products, transaction type, coupons used, payment method, and/or the like. In one embodiment, the financial management system 300 is a computer system of a bank or other financial institution configured to process financial transactions (e.g., credit or debit card transactions and/or the like) for consumers and/or merchants having accounts with the bank or other financial institution.

FIG. 4 provides a block diagram illustrating the merchant system 400 of FIG. 1 in more detail in accordance with an embodiment of the invention. The merchant system 400 generally includes a processor 410 communicably coupled to a communication interface 430 and a memory system 420. Like the processor 210 described with respect to FIG. 2, the processor 410 comprises the circuitry and logic to perform the various functions of the merchant system 400 described herein. The communication interface 430 includes a network interface 432 and a user interface 434, which may be similar to those described above with respect to FIG. 2.

The memory system 400 may also include a web browser application 422 and/or a mobile commerce system client application 421 which comprise computer-executable instructions/code executed by the processor 410 to implement at least some of the functions of the merchant system 400 described herein. These applications also typically provide a graphical user interface (GUI) on the user interface 434 that allows a merchant representative to communicate with the mobile commerce system 500 and/or other devices. In one embodiment of the invention, when the merchant decides to enroll in the mobile commerce program, a merchant representative downloads the mobile commerce system client application 421 from the mobile commerce system 500. In other embodiments of the invention, the merchant interacts with the mobile commerce system 500 by using the web browser application 220 to access and log into a website of the mobile commerce system 500. The merchant may use these applications to enroll in the mobile commerce system 500 and to create merchant preferences and/or offer specifications for the mobile commerce system 500.

The memory system 420 may also include consumer transaction data 424 and/or offer specifications 423 stored therein. The offer specifications 423 may include the parameters of one or more offers (e.g., advertisements, discounts, coupons, promotions, and/or the like) that the merchant desires for the mobile commerce system 500 to disseminate. The offer specifications 423 may include such information as products identifiers, images, discounts, prices, add-on products, offer expiration information, offer effective dates, offer terms and conditions, offer modifications, and/or the like. The offer specifications 423 may also include information about how the merchant wants the offers disseminated to consumers 110. This information may include, for example, demographic information about a target consumer audience, rules for when to provide an offer based on the consumer's location relative to the merchant or a competitor of the merchant, rules for when to modify an offer based on a rejection, a survey, or location information, rules for when to provide a survey, and/or the like.

In some embodiments, the merchant system 400 tracks consumer transaction data 424 for consumers doing business with the merchant. In some embodiments of the invention, the consumer transaction data 424 is communicated to the mobile commerce system 500 so to use in determining how offers should be targeted and/or whether offers have been accepted. In some instances, this information is provided in real time or near real time relative to when the transaction between the consumer 110 and the merchant actually occurs.

The merchant system 400 also includes one or more POS devices 480 configured to obtain information from a consumer transaction device 115 and/or mobile device 200 and/or other consumer input used to process a financial transaction. In this regard, the POS devices may include, for example, a cash register, a user input device, a user output device, and a transaction device reader such as a magnetic stripe reader, a barcode reader, a NFC transceiver, and/or the like. The consumer transaction data 424 may be at least temporarily stored in the memory system 420 before being communicated to the financial management system 300 and/or the mobile commerce system 500.

The merchant system 400 may also include, in some embodiments, one or more positioning system devices 470, such as one or more proximity sensors for sensing a consumer mobile device 200 entering or leaving the merchant's location. For example, in one embodiment of the invention, the merchant has one or more sensors/transceivers located at the entrances and exits to the merchant's location that are configured to detect when a consumer 110 going through the entrance or exit holding a mobile device 200 that is configured to communicate a consumer identifier to the sensors/transceivers. The consumer location information gathered by the positioning system devices 470 is then communicated to the mobile commerce system 500 so that the mobile commerce system 500 knows whether the consumer 110 is at, entering, or exiting the merchant facility. In other embodiments of the invention, the merchant may be mobile and, as such, some embodiments of the positioning devices 470 are GPS devices indicating the location of the merchant so that the mobile commerce system 500 can determine the merchant's location relative to the location of one or more consumers. It will be appreciated that, in some embodiments of the invention, the merchant system 400 does not have any positioning system devices 470 since, for example, a GPS system or a similar system not associated with the merchant system 400 may be used to determined the location of the consumer 110, while the merchant locations may already be known and stored in the memory of the mobile commerce system 500.

FIG. 5 provides a block diagram illustrating the mobile commerce system 500 of FIG. 1 in more detail in accordance with an embodiment of the invention. The mobile commerce system 500 generally includes a processor 510 communicably coupled to a communication interface 530 and a memory system 520. Like the processor 210 described above with respect to FIG. 2, the processor 510 comprises the circuitry and logic to perform the various functions of the mobile commerce system 500 described herein. The communication interface 530 includes a network interface 532 and a user interface 534, which may be similar to those described above with respect to FIG. 2. The memory system 520 includes a mobile commerce system application 521 including computer-executable processor code that instructs the processor 510 to perform the various functions described herein as being performed by the mobile commerce system 500. The memory system 520 also includes consumer preferences 522, shopping specifications 523, transaction data 524, location data 525, and survey results 528 stored therein. The memory system 520 also includes surveys 527 and targeted offer specifications 526 for a plurality of different merchants.

The merchant and consumer location data 525 includes location data for each of a plurality of participating consumers 110 and each of a plurality of merchants. The consumer location data is received from the positioning system 150, which as described above, determines the consumer's current location and/or travel history by tracking the position of the consumer's mobile device 200 over time. The merchant location data can be determined by public directories containing addresses of various merchants, from the merchant system 400 for some merchants, from the positioning system 150, the financial management system 300, and/or other systems or entities that can provide addresses or other location information for one or more merchants.

The consumer transaction data 524 includes information about one or more consumer transactions, such as transaction amount, time, location, merchant, products, transaction type, coupons used, payment method, and/or the like. The mobile commerce system 500 may receive the consumer transaction data 524 from the financial management system 300, the merchant system 400, the consumer mobile device 200, and/or other systems. In some embodiments of the invention, the mobile commerce system application 521 (when executed by the processor 510) maps the consumer transaction data 524 against the merchant and consumer location data 525 by, amongst other things, correlating the time of each consumer transaction with the consumer's location at that time and by comparing the consumer's location with the locations of a plurality of merchants. In this way, shopping trends are identified for each consumer 110 based on an analysis of each consumer's travels when the consumer is shopping and overlaying this information with the consumer's purchases and various merchant locations.

The consumer preferences 522 may include, for example, information used by the mobile commerce system 500 to determine what type of offers the consumer 110 may be interested in, when the consumer 110 would like to receive offers, how the consumer 110 would like to receive offers, when the consumer 110 would like for the consumer's location to be tracked by the mobile commerce system 500, and/or the like. The consumer preferences 522 may be, for example, consumer-generated and received from the consumer mobile device 200. The consumer preferences 522 may also be determined by the mobile commerce system 500 automatically based on trends identified in the consumer transaction data 524. Some examples of consumer preferences 522 are described in greater detail below with reference to the flow charts.

The consumer shopping specifications 523 may include, for example, information about a consumer's current or future shopping event and may include such information as the product or type of product that the consumer 110 is in the market for, where the consumer 110 is currently shopping or plans to shop (e.g., geographic area, store name, and/or the like), when the consumer 110 plans to shop, the consumer's budget or budget range, and/or the like. The consumer shopping specifications 523 may also include one or more consumer-defined purchase thresholds such as, for example, a maximum price that the consumer 110 is willing to spend on a product or product type, a maximum distance the consumer 110 is willing to travel from the consumer's current location or a specified location to purchase the product, and/or the like. The consumer shopping specifications 523 may be, for example, created by the consumer 110 and received from the mobile device 200. In one embodiment of the invention, the consumer 110 can use the consumer mobile device 200 to capture shopping specifications from the consumer's surroundings. For example, information about a particular product that the consumer desires can be captured by capturing an image of the product, an identifier (e.g., a barcode, UPC, or SKU number) located on the product, and/or the like with the camera 280 or other imaging device of the consumer mobile device 200. Identifiers or keywords related to a product may also be entered through a keyboard or voice command. The mobile commerce system 500 may be configured to receive such product information as shopping specifications 523 and find offers related to the products identified by this information. Some examples of user-defined shopping specifications 523 are described in greater detail throughout this disclosure and, in particular, with reference to the flow charts and FIG. 11.

The merchant surveys 527 are one or more surveys that, in some embodiments, are sent to a consumer 110 from the mobile commerce system 500 to determine information from the consumer 110, such as information about why a consumer 110 did not accept a particular offer from a particular merchant. The surveys may be generic or merchant-specific. The surveys may be prepared by users of the mobile commerce system 500 and/or of the merchant system 400. The survey results 528 include the consumer's answers to the one or more questions contained in one or more surveys 527. Some examples of the surveys 527 and/or survey responses 528 are described in greater detail herein with reference to the flow charts and FIG. 12.

The merchant targeted offer specifications 526 are customized (e.g., personalized or targeted) offers from one or more merchants to one or more consumers 110. These offers 526 may include advertisements, discounts, promotions, information, coupons, and/or the like and may be generated by users of the mobile commerce system 500 and/or of the merchant system 400. The offers 526 are then at communicated over the network 120 to the mobile device 200 and presented to the consumer 110 by the mobile commerce system client application 221 and/or web browser application 222 of the mobile device 200. Some examples of targeted offers 526 are described in greater detail herein with reference to the flow charts and FIG. 11.

FIG. 6 provides a flow chart illustrating an interactive mobile commerce process 600 in accordance with an embodiment of the invention. As represented by block 602, the consumer 110 downloads the mobile commerce client application 221 to the consumer's mobile device 200. In one embodiment, the consumer uses the web browser application 222 and the network interface 260 of the mobile device 200 to connect to the mobile commerce system 500 over the network 120 to download to the mobile commerce system client application 221 from the mobile commerce system 500. For example, where the mobile commerce system 500 is maintained by or otherwise associated with a financial institution, the consumer 110 may use the mobile device 200 to connect to the financial institution's mobile banking website on the Internet and then download the mobile commerce system client application 221. In other embodiments, the mobile commerce client application 221 comes pre-installed on the mobile device 200 or is stored on the mobile device 200 in other ways. In still other embodiments of the invention, a mobile commerce system client application 221 is not required and, instead, the mobile commerce system 500 utilizes standard hardware and software applications of the mobile device 200, such as a standard web browser application 222, to communicate with the consumer 110 and/or perform the other functions of the mobile device 200.

As represented by block 604, the consumer 110 then initiates a shopping event, thereby activating the location tracking feature of the mobile commerce system client application 221 and/or mobile commerce system application 521. For example, in one embodiment, the consumer 110 initiates a shopping event by, for example, using the user interface of the mobile device 200 to activate the mobile commerce system client application 221 and its tracking features. In other embodiments, the mobile commerce system client application 221 is always running, running on a schedule, or activated in other ways. In some embodiments, the consumer 110 must be authenticated, via, for example a username and password, by the mobile commerce system 500 and/or the mobile commerce system client application 221 before customized offers are displayed on the consumer mobile device 200. In other embodiments of the invention, authentication is not required.

As represented by block 606, the mobile commerce system application 521 tracks the consumer's location to determine the consumer's location relative to one or more merchants. For example, in one embodiment of the invention, the positioning system 150 determines the location of the consumer mobile device 200 relative to the world or other geography (e.g., via a GPS system or similar system) and then compares the determined location to the known location (e.g., addresses) of one or more merchants. In another example embodiment, proximity sensors are located proximate to one or more merchants and these sensors can determine when the consumer mobile device 200 is visiting, approaching, and/or leaving the one or more merchants. For example, participating merchants may install sensors at each entrance and exit of the merchant location and determine that a consumer 110 is visiting the merchant location by sensing the positioning system device 275 of the consumer mobile device 200 when the consumer 110 walks through an entrance with the consumer mobile device 200. In such an embodiment, the mobile commerce system 200 may determine that the consumer 110 is leaving the merchant location by either having dedicated exits, by determining the proximity of the consumer mobile device 200 to an exit, or by determining that the consumer 110 must be exiting if the consumer mobile device 200 is sensed in an entrance/exit after being sensed when the consumer 110 entered the merchant location. In another embodiment of the invention, the consumer mobile device 200 has a sensor configured to sense transmitters or other devices located proximate one or more merchants (e.g., at the entrances and exits of the merchant's location) and then communicates the sensed information to the mobile commerce system 500 where a look-up database is used to determine the merchant that the consumer 110 is visiting, approaching, and/or exiting.

As represented by block 608, over time, the mobile commerce system application 521 maps the consumer's transaction data relative to the consumer's location data to determine the consumer's shopping trends and habits. In some embodiments of the invention, the mobile commerce system 500 records the merchants that are visited by each of a plurality of consumers and whether the consumers make purchases or other transactions at each of these merchants. For example, the mobile commerce system 500 may store a location transaction variable for each consumer and merchant combination and give the location transaction variable a value of one whenever the consumer visits the merchant and makes a purchase, and a value of zero whenever the consumer visits the merchant and does not make a purchase. In this way or in other ways, the mobile commerce system 500 creates a “map” of sorts that shows a consumer's shopping habits, such as which stores the consumer frequents, the number or percentage of times the consumer makes a purchase from a merchant relative to the number of visits by the consumer to the merchant, how often the consumer uses coupons or takes advantages of special offers or discounts, etc.

As represented by block 610, the mobile commerce system application 521 (and/or mobile commerce system client application 221) prompts the consumer 110 to enter shopping specifications for a current shopping event. For example, in one embodiment of the invention, the mobile commerce system application 521 and/or the mobile commerce system client application 221 uses the user interface, such as the display 330, of the consumer mobile device 200 to provide a form to the consumer 110 that allows the consumer 110 to enter one or more shopping specifications 225. The consumer 110 uses the user input devices 240 to enter the shopping specifications 225, which are then stored at least temporarily in the memory 220 and then communicated from the mobile device 200 to the mobile commerce system 500. The shopping specifications 225 can be, for example, any information about what the consumer 110 is shopping for and where the consumer 110 wants to shop. For example, the consumer 110 may enter information about the product(s) for which the consumer 110 is shopping, such as, but not limited to, product types, product names, brand names, product model numbers or other identifiers, product images, and/or the like. The shopping specifications 225 can also provide information about who the consumer 110 is shopping for, such as, but not limited to, the type of person the consumer is shopping for (e.g., male, female, child, adult, senior, etc.), the event that the consumer is shopping for (e.g., night out, birthday gift, wedding gift, baby shower gift, party favors, etc.), and/or the like. The shopping specifications 225 can also provide information about the amount the consumer 110 is willing to spend, such as the price or price range that the consumer desires to spend for a particular product or shopping event. The shopping specifications 225 can also provide information about where the consumer 110 desires to shop, such as, but not limited to, within some specified or pre-defined distance from the consumer's current location, within some specified or predefined distance from some other specified location, within a specified geographic area (e.g., a city, state, county, town, country, village, zip code, region, area code, roadway, and/or the like), at certain specified merchants, within a specified structure such as a particular shopping mall or other retail location, and/or the like. The shopping specifications 225 can also provide information about the other shopping desires of the consumer 110, such as, but not limited to, the number of products the consumer 110 is looking to purchase, the date(s) and/or time(s) the consumer 110 plans to shop, the discounts and/or other offers that the consumer 110 is looking for, the delivery options the consumer 110 is looking for, the installation or assembly options the consumer 110 is looking for, the warranty options that the consumer 110 is looking for, and/or the like.

As represented by block 612, the mobile commerce system application 521 determines one or more offers in which the consumer 110 may be interested based on the consumer's current location 525, location-based transaction trends identified in the consumer transaction data 524, and/or shopping specifications 523 for the current shopping event. In this regard, a merchant using the merchant system 400 can log into the mobile commerce system 500 via the network 120 and use the mobile commerce system 500 to generate one or more offers 526 and specifications for the offers that include, for example, effective and expiration dates, rules for targeting consumers, target consumer demographic information, participating merchant locations, offer terms and conditions, available offer modifications or options, and/or the like. These offer specifications 526 are stored in the memory 520 of the mobile commerce system 500. The mobile commerce system 500 then constantly or periodically identifies the most relevant targeted offers 526 for each consumer 110 based on the consumer's current location, demographic information, shopping specifications 523, survey results 528, and/or past shopping trends.

As represented by block 614, the mobile commerce system application 521 then distributes the one or more offers to the consumer's mobile device 200 where the offers are presented, for example, on the display 300 via a GUI provided by the mobile commerce system client application 221. In some instances, the offer is merely an advertisement and is considered accepted when the consumer 110 makes a purchase of the advertised product. In other instances, the offer may be affirmatively accepted or rejected by the consumer 110 interacting with the mobile commerce system client application's GUI. Such an acceptance or rejection may then be communicated to the mobile commerce system 500. In some embodiments, an offer is redeemed by the mobile commerce system 500 indicating to the financial management system 300 the terms of an offer provided to the merchant and the financial management system 300 then identifying from the consumer transaction data 322 whether a qualifying transaction is made by the consumer 110. In other embodiments, the consumer mobile device 200 communicates the offer to the merchant system's POS device 480 (using, for example, NFC capabilities of the payment network interface 270), and the merchant system 400 then honors the promotional offer at the POS, similar to how the merchant system 400 would identify and honor a paper coupon. Any discount, rebate, free gift, and/or other promotion associated with an offer can be provided to the consumer 110 during or after the transaction that accepts the offer. In some embodiments, the discount or rebate is paid by the merchant, while in other embodiments the discount or rebate is paid by the financial institution or other entity.

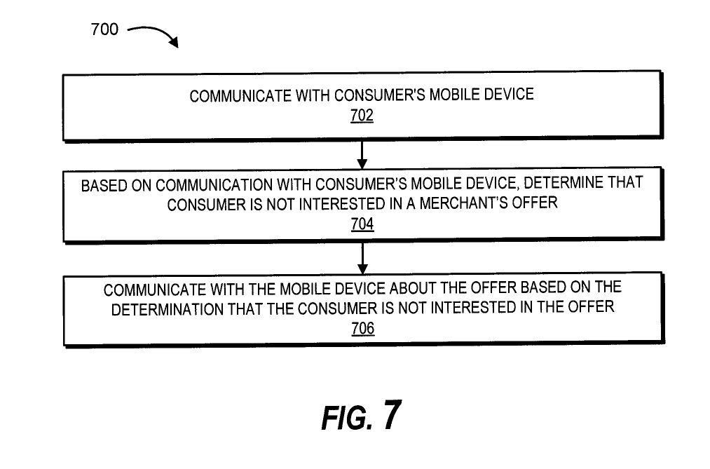

In some embodiments of the invention, the mobile commerce system 500 is even responsive to the real time or near real time actions or decisions of the consumer 110 that may indicate rejection of a merchant's offer. For example, many merchants, after realizing that a consumer 110 is in their store looking for a particular product, would like to know, in a timely manner, if the consumer 110 is leaving without purchasing the intended product. In this way, a merchant could possibly try to react quickly to try another approach to complete a sale to the consumer 110 with, for example, a better offer, a different offer, more information, more assistance, and/or the like. In this regard, FIG. 7 provides a flow chart illustrating a process 700 of an interactive feature of a mobile commerce process in accordance with an embodiment of the invention.

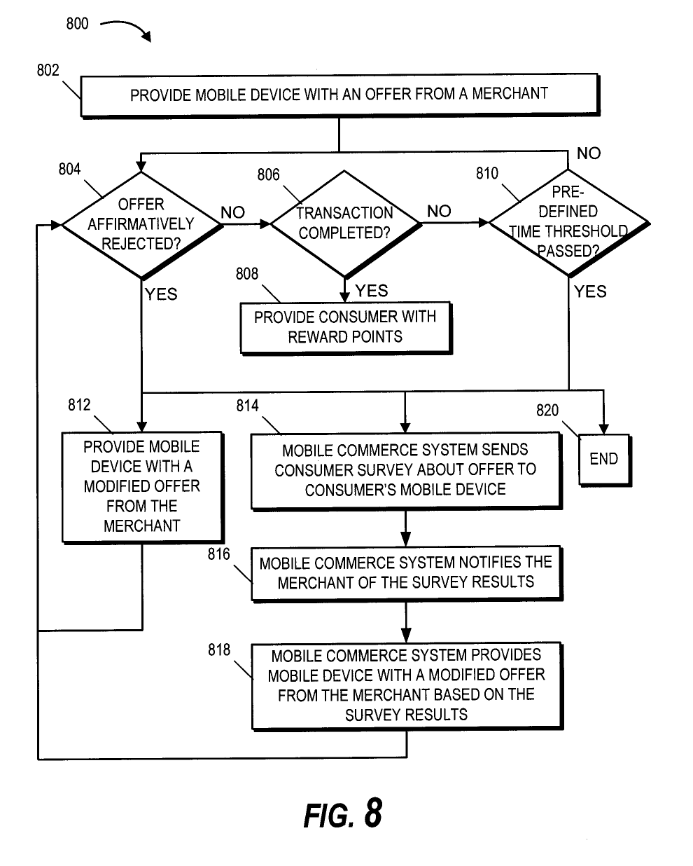

As represented by block 702, the mobile commerce system 500 communicates with consumer's mobile device 200. As represented by block 704, based on communication with consumer's mobile device 200, the mobile commerce system 500 determines that the consumer 110 is not interested in a merchant's offer. The merchant's offer may be an offer for the merchant or a product of the merchant that was sent to the consumer's mobile device 200 by the mobile commerce system 500. In other embodiments, however, the merchant's offer may be presented to the consumer 110 in other ways, such as through an in-store advertisement or product display. The mobile commerce system 500 may use a variety of techniques for determining that the consumer 110 is not interested in a merchant's offer. For example, the consumer could affirmatively reject an offer using the mobile device 200, the mobile commerce system 500 could use near real time consumer transaction data 524 and location data 525 to determine that the consumer is leaving the merchant without making a purchase, and/or the mobile commerce system 500 could identify a trend in which a consumer frequently visits a particular merchant without making a purchase. As represented by block 706, based on a determination that the consumer 110 is not interested in the offer, the mobile commerce system 500 then communicates with the mobile device 200 about the offer. For example, the mobile commerce system 500 may send a survey to the consumer 110 and/or present a modified offer to the consumer 110. Some examples of this process 700 are described below with reference to FIGS. 8 through 10.

FIG. 8 provides a flow chart illustrating one example embodiment 800 of the process of FIG. 7 where consumer interest in an offer is determined and surveys and/or modified offers are provided based on the interest determination. As represented by block 802, the mobile commerce system 500 provides the consumer 110 with an offer from a merchant. For example, the mobile commerce system 500 may determine that the consumer 110 has walked into a particular merchant's store and, in response to this determination, the mobile commerce system 500 may then send a coupon, advertisement, discount, or other offer to the consumer's mobile device 200.

In some embodiments of the invention, the offer is displayed on the consumer's mobile device 200 and the consumer 110 has the option to affirmatively reject the offer by, for example, clicking an “ignore” button, “reject” button, “delete” button, or the like presented in the GUI of the mobile commerce system client application 221. As represented by block 804, the mobile commerce system 500 monitors whether it receives an affirmative rejection of the offer from the consumer's mobile device 200.

As long as an offer is not affirmatively rejected, the mobile commerce system 500 also monitors whether a transaction corresponding to the offer is completed, as represented by block 806. For example, in one embodiment of the invention, the mobile commerce system 500 is in constant or frequent communication with the financial management system 300. When the consumer 110 accepts an offer using the consumer transaction device 115 (which may also be the consumer's mobile device 200) in conjunction with the merchant's POS devices 480, the financial management system 300 receives information about the transaction via, for example, a request to authorize the financial component of the transaction. This transaction information is then communicated to the mobile commerce system 500 in, in some embodiments, real time or near real time. In this way, the mobile commerce system 500 can determine quickly (e.g., in real time or near real time) whether the merchant's offer has been accepted by the consumer 110. In other embodiments, the mobile commerce system receives information about the offer being accepted from the merchant system 400 or the consumer mobile device 200 instead of or in addition to from the financial management system 300. In some embodiments of the invention, if the offer is accepted by virtue of a transaction corresponding to the offer being completed, the mobile commerce system 500 awards the consumer 110 with rewards points, as represented by block 808. The mobile commerce system 500 may also cease displaying the offer on the mobile device 200 or show on the mobile device that the offer has been accepted and that the consumer 110 has received a certain amount of reward points for the acceptance.

In some embodiments of the invention represented by block 810, as long as the offer is not affirmatively rejected or accepted, then the mobile commerce system 500 also determines whether a pre-defined time threshold has passed. If the pre-defined time threshold has not passed, then the mobile commerce system 500 continues to monitor acceptance or rejection of the offer. However, if the threshold has passed, then the offer is considered to be, at least temporarily rejected/expired, and the process 800 proceeds to block 812, 814, or 820, which are described in greater detail below. In some embodiments of the invention, the pre-defined time period and/or the rules for determining this time period are specified by the consumer 110 and stored in the consumer preferences 522, while in other embodiments they are determined by the merchant and stored in the targeted offer specifications 526, or determined by the financial management system 300 or other owner of the mobile commerce system 500.

If, in step 804, the mobile commerce system 500 determines that the offer is affirmatively rejected by the consumer 110, then the process 800 proceeds to block 812, 814, or 820. In some embodiments, the process simply ends, as represented by block 820.

In another embodiment of the invention, the mobile commerce system 500 provides the consumer mobile device 200 with a modified offer from the merchant. This modified offer may be provided immediately as soon as the mobile commerce system 500 determines that the consumer 110 rejected or did not timely accept the earlier offer. For example, the mobile commerce system 500 may have pre-defined modifications for the offer already stored in the merchant targeted offer specifications 526. The modification may be, for example, a reduced price, a different product, a free gift, faster delivery, and/or other type of promotion.

In other embodiments of the invention, the rejection of the offer is first communicated to the merchant system 400. In some instances, the merchant system 400 has pre-defined offer modifications associated with some offers stored in its memory system and, in some instances, these modifications/revised offers are then communicated to the mobile commerce system 500 which then sends the modified offer to the consumer mobile device 200. In some embodiments of the invention, a user of the merchant system 400 monitors these rejected offers and, where appropriate, creates customized offer modifications to send quickly back to the consumer 110. The automatically-generated and/or user-generated modifications may be based on specific modification rules, such as real-time inventory information, new model releases, and/or the like. In some cases the modified offer is a new offer but in others it's based at least partially on the rejected offer and may be an improvement on the rejected offer in at least one respect.

For example, in one embodiment of the invention, a consumer walks into an electronics store and the consumer's shopping preferences indicate that the consumer is looking for a television. The mobile commerce system presents an offer for 5% off of any television in the store when the consumer walks into the store. The consumer affirmatively rejects the offer or a pre-defined time period passes and the consumer has yet to purchase a television, so the mobile commerce system then, according to merchant-generated rules, provides a modified offer to the consumer for 10% off a particular brand of television of which the merchant currently has too much inventory.

In other embodiments of the invention, the mobile commerce system 500 sends a survey 527 to the consumer mobile device 200, where the survey 527 inquires about the reasons behind the consumer's decision not to accept the offer, as represented by block 814. In some embodiments, the survey 527 is sent after the rejection, while in other embodiments of the invention the survey 527 is part of the rejecting process. For example, in embodiments where the consumer 110 can affirmatively reject the offer by clicking on an appropriate button, the mobile commerce system client application 221 may automatically, upon the consumer clicking the appropriate button, ask the consumer 110 why the offer is being rejected. For example, the mobile commerce system 500 could ask the consumer 110 whether the consumer 110 rejected the offer because the consumer 110 was not interested in the product or because the offer was not good enough. The survey 527 may also ask specific questions about why the consumer 110 rejected the offer and/or about what type of offer the consumer 110 is looking for. FIG. 12, described in greater detail below, provides an example of a survey 527.

As represented by block 816, the mobile commerce system 500 then notifies the merchant of the survey results. For example, the mobile commerce system 500 may send them to the merchant system 400 or provide a notification to the merchant system 400 informing the merchant that the merchant can log into the mobile commerce system 500 to access the survey results. The merchant can then view the reasons for why the consumer 110 did not accept the offer and, in some cases, may be able to modify the offer based on this feedback. This may be done automatically or by a user based on one or more business rules. As represented by 818, the merchant provides a modified offer to the mobile commerce system 500 which then provides the consumer mobile device 200 with the modified offer, the offer having been modified based at least in part on the survey results.

For example, in one embodiment of the invention, a consumer walks into an electronics store and the consumer's shopping preferences indicate that the consumer is looking for a television. The mobile commerce system presents an advertisement for a television on the consumer's mobile cell phone. The consumer affirmatively rejects the offer or a pre-defined time period passes and the consumer has yet to purchase a television, so the mobile commerce system then provides a survey to the consumer's cell phone asking the consumer why the consumer has not accepted the offer. The consumer responds in the survey that a competitor of the merchant is offering a television at the same price but with free high-definition cables. The mobile commerce system provides this survey response to the merchant and the merchant agrees to provide free cables to the consumer along with a ten dollar gift certificate to the merchant's store. This modified offer is then sent to the consumer's mobile device by the mobile commerce system.

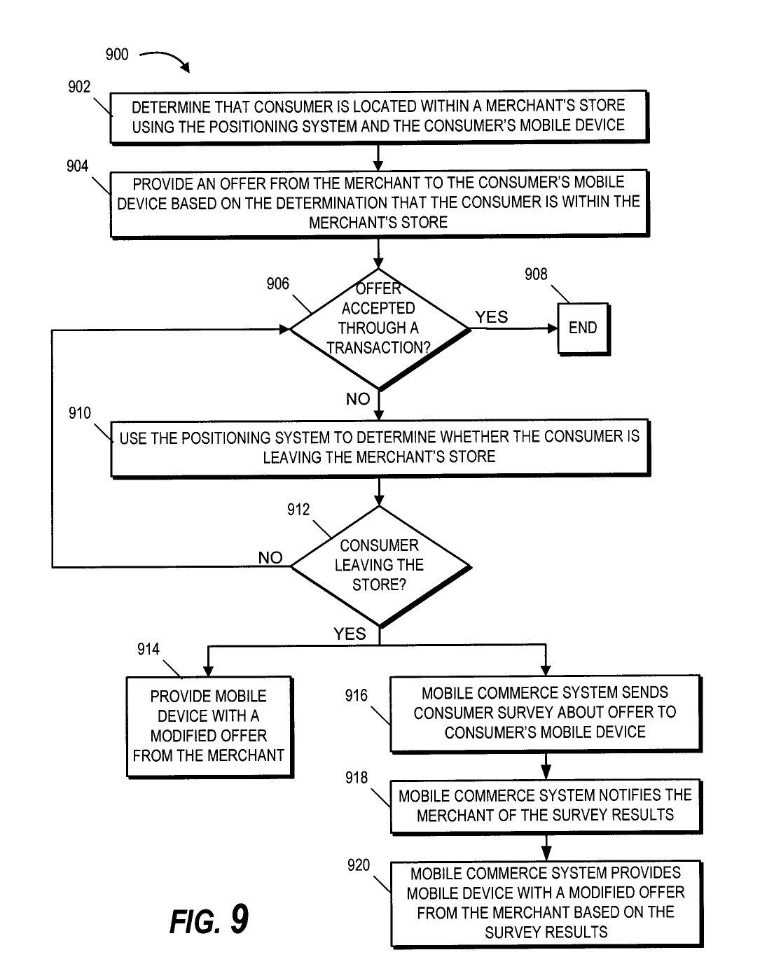

FIG. 9 provides a flow chart illustrating another example embodiment 900 of the process of FIG. 7 where consumer interest in an offer is determined based on mobile device location information, and where surveys and/or modified offers are provided based on the interest determination.

As represented by block 902, the mobile commerce system determines that a consumer 110 is located within a merchant's store using the positioning system 150 in conjunction with the consumer's mobile device 200. As described above, this determination may be made using a GPS or similar system that identifies the location of the consumer mobile device 200 generally, and/or using a proximity sensor system proximate the merchant's store that identifies whether the consumer mobile device 200 is in close proximity to the merchant's store or has entered the merchant's store.

As represented by block 904, the mobile commerce system 500 provides an offer from the merchant to the consumer's mobile device 200 based at least in part on the determination that the consumer 110 is within the merchant's store. As represented by block 906, the mobile commerce system 500 then determines whether the offer was accepted based on real time or substantially up-to-date financial transaction information. For example, the mobile commerce system 500 may determine from financial information tracked by the financial management system 300 whether the consumer 110 made a purchase from the merchant corresponding to the offer.

As represented by block 908, if the mobile commerce system 500 determines that the offer has been accepted by the consumer 110, then the process 900 may end, as represented by block 908. However, as long as the mobile commerce system 500 determines that the offer has not yet been accepted by the consumer 110, then the mobile commerce system 500 continues to use the positioning system 150 to determine whether the consumer 110 is leaving the merchant store, as represented by blocks 910 and 912.

As illustrated, as long as the mobile commerce system 500 does not determine that the consumer 110 is leaving the merchant store, then the process 900 may continue to perform the actions of blocks 906 through 912 until the consumer 110 either accepts the offer, affirmatively rejects the offer, or leaves or begins to leave the merchant's store.

If, in step 912, the mobile commerce system 500 determines that the consumer 110 is leaving the store, then the process 900 proceeds to either block 914 or 916. More specifically, in some embodiments of the invention, the mobile commerce system 500 provides the consumer mobile device 200 with a modified offer from the merchant, as represented by block 914 and as described above with reference to, for example, block 812 of FIG. 8. In other embodiments, the mobile commerce system sends the consumer a survey about the offer (block 916), notifies the merchant of the consumer's survey response (block 918), and provides a modified offer from the merchant (block 920), the offer having been modified based on the survey results. The steps identified by blocks 916, 918, and 920 may be similar to the steps described above with reference to blocks 814, 816, and 818, respectively.

For example, in one embodiment of the invention, a positioning system determines that a consumer walks into an electronics store by identifying the consumer's cell phone within the store. The consumer's shopping preferences currently stored in the mobile commerce system application indicate that the consumer is looking for a television. The mobile commerce system presents an offer for 5% off of a particular television on the consumer's cell phone. After some time, the mobile commerce system senses the consumer's mobile device going through an exit of the electronic store and, determines based on this information, that the consumer is leaving the electronics store. The mobile commerce system is in communication with the consumer's bank and determines from the consumer's bank account transaction information that the consumer has not initiated a purchase transaction at the merchant and, therefore, assumes that the consumer is leaving this particular merchant without having purchased a television. In one embodiment, the mobile commerce system then provides the consumer with a survey asking the consumer why the consumer has not accepted the merchant's offer. The consumer responds in the survey that the consumer did not want the brand of television in the offer and that the brand that the consumer wanted was too expensive. The mobile commerce system then provides this survey response to the merchant and the merchant agrees to provide 2% off of the consumer's desired television. This modified offer is then sent to the consumer's mobile device by the mobile commerce system.

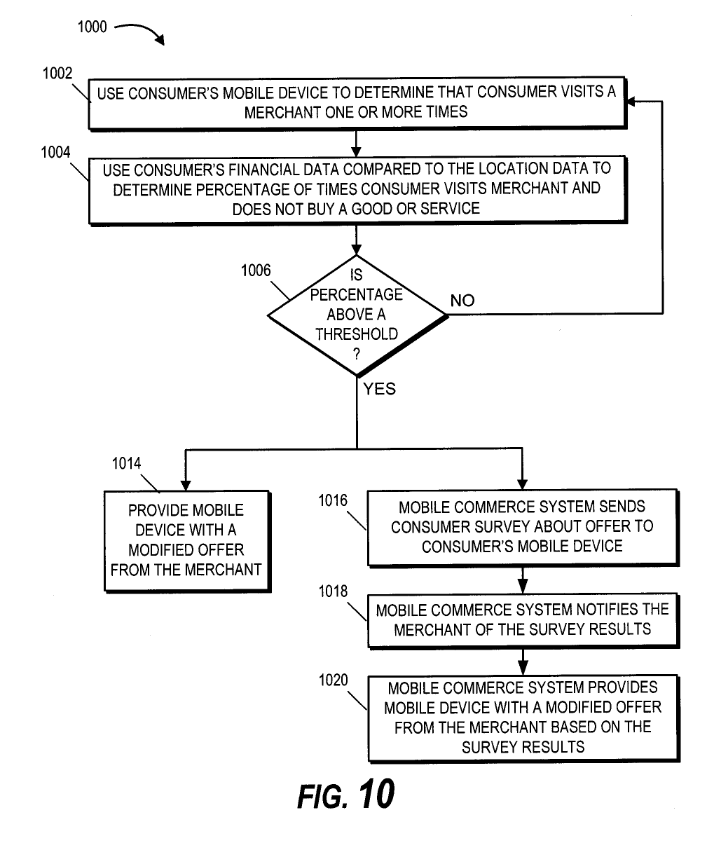

FIG. 10 provides a flow chart illustrating yet another example embodiment 1000 of the process of FIG. 7 where systematic consumer lack of interest in a merchant is determined based on mobile device location information and financial transaction information, and where surveys and/or modified offers are provided based on the determination of systematic lack of interest. As represented by block 1002 and as described elsewhere herein in greater detail, the mobile commerce system 500 can use the consumer's mobile device 200 to determine that a consumer 110 visits a merchant one or more times. As represented by block 1004, the mobile commerce system then uses the consumer's financial data compared to the location data to determine the percentage of times that the consumer 110 visits the merchant and does not purchase a product. As represented by decision diamond 1006, the mobile commerce system 500 then determines id this percentage is above a threshold value.

If the percentage is not above the threshold, then the mobile commerce system 500 continues to monitor the consumer's location and transaction history to determine shopping trends. If the percentage is above the threshold, then the process 1000 then proceeds to either block 1014 or 1016. More specifically, in some embodiments of the invention, the mobile commerce system 500 provides the consumer mobile device 200 with a modified offer from the merchant, as represented by block 1014 and as described above with reference to, for example, block 812 of FIG. 8. In other embodiments, the mobile commerce system 500 sends the consumer 110 a survey about the offer (block 1016), notifies the merchant of the consumer's survey response (block 1018), and provides a modified offer from the merchant (block 1020), the offer having been modified based on the survey results. The steps identified by blocks 1016, 1018, and 1020 may be similar to the steps described above with reference to blocks 814, 816, and 818, respectively.

For example, in one embodiment of the invention, a positioning system determines, based on the location of the consumer's mobile terminal, that a consumer has visited a particular merchant three times within two months and has never made a purchase. After the third time, the mobile commerce system automatically provides the consumer with a survey, via the mobile terminal, asking the consumer why the consumer has not made any purchases from the merchant (i.e., has not accepted any in-store offers from the merchant). The consumer responds in the survey that the consumer requires assistance and never receives any from the merchant employees. The mobile commerce system then provides this survey response to the merchant and, for example, the merchant agrees to provide 10% off of the consumer's next purchase to try to get the consumer to give the merchant another chance. This modified offer is then sent to the consumer's mobile device by the mobile commerce system. The merchant may then also take appropriate action to improve customer service as the merchant location visited by this consumer.

FIG. 11 provides example consumer-specified shopping specifications and an example mobile offer interface 1100 in accordance with an embodiment of the invention. The mobile offer interface 1100 is an example of a GUI that may be presented on the display 230 of the consumer mobile device 200 by the mobile commerce system client application 221. In the exemplary embodiment of the invention, the mobile offer interface 1100 has two sections, a purchase thresholds section 1110, and an offers section 1130. The purchase thresholds section 1110 illustrates the purchase thresholds (i.e., consumer shopping specifications) submitted to the mobile commerce system 500 by the consumer 110, as described above.

In the illustrated embodiment, the purchase thresholds include maximum price 1112, distance from the consumer's current location 1114, and product type 1116. For example, the consumer in FIG. 11 is currently shopping for a high definition television (HD TV) that can be purchased within twenty-five miles of the consumer's current location and that has a maximum price of $2,743.41.

As described above, the mobile commerce system client application 221 communicates with the mobile commerce system 500 to determine and display the offers most relevant to the purchase thresholds in the mobile offer interface 1100. The offers section 1130 then displays the merchants 1132 that can offer the same or similar product to the one identified by the consumer's purchase thresholds. The offer description 1134 illustrates what the offer is (the same product or a similar one), while the distance 1136 illustrates the current distance from the consumer 110 to the merchant. The price 1138 represents the price for the product being offered.

In other embodiments of the invention, the offers section 1130, another section, or a separate tab displays related products in which the consumer 110 may be interested. For example, if a consumer is searching for a forty-six inch LCD TV the consumer may also be interested in DVD players, or services such as Direct TV®. In one embodiment of the invention, a “see related offers” section button 1140 or tab is selected by the consumer 110 in order to view any related offers identified by the mobile commerce system 500. However, in other embodiments, the related offers are displayed in the offers section 1130 along with the product for which the consumer 110 is searching. In some embodiments of the invention, the mobile offer interface 1100 has an advertisement section 1150 that displays one or more targeted advertisements to a consumer 1110 based on the consumer's previous purchasing history, profile information, and/or location information based on the current location of the consumer 110.

The offers identified by the mobile offer interface 1100 may be determined in a number of ways. In one exemplary embodiment, a financial institution maintains the mobile commerce system 500 and has arrangements with merchants that allow the financial institution to provide certain products to consumers through the mobile offer interface 1100 at discounted prices. The financial institution will display various products that are the subject of a discount coupon, rebate, or the like. The products will sometimes be displayed with the items carrying the greatest discount, coupon, rebate, etc., first. The discount, coupon, rebate, etc., can be the merchant's normal offer or can be the subject of a separate arrangement with the financial institution. In other embodiments, the merchant may pay a fee to the financial institution per month, week, etc., or a flat fee, etc., in exchange for the financial institution showing one or more of the merchant offers to consumers. The size of discounts provided, and in some embodiments the fees paid by merchants, can be based on the number of hits the offer/website of the merchant receives, the number times the offer is displayed, the number of consumers who accept the offer by making a purchase, and/or the rank of the offer, etc. In some embodiments of the invention the merchant may not offer the product at a discount, but instead the financial institution may subsidize the offer by providing the discount itself. In this instance, the financial institution would pay the merchant the full price of the product or service at the time of sale, but debit the consumer's account a discounted price or rebate the consumers at some future point in time. The financial institution could make up for the discounts by charging the merchants a fee to display the offer to the consumer or by taking payments from the merchant for all of the discounts on offers provided within a certain time period.

In some embodiments of the invention, a notification indicator, such as a dollar sign or other icon or indicator could appear somewhere on the display of the consumer's mobile device 200 of the device could vibrate once or provide another signal to the consumer whenever a new offer is sent to the mobile device 200 (e.g., as the consumer travels, offers in the mobile offer interface 1100 may change based on changes in the consumer's location). This would inform the consumer that there is a new offer shown in the mobile offer interface 1100. In other embodiments, the notification indicator could appear in the tool bar at the top or bottom of the web browser or in other areas of the web browser.

FIG. 12 provides an example mobile consumer survey and survey interface 1200, in accordance with an embodiment of the invention. The survey interface 1200 includes a timestamp 1202. The consumer 110 may receive multiple offers on a given shopping trip. It can be important to provide the consumer 110 with a frame of reference for the survey 1200. Similarly, the example survey interface 1200 includes an offer box 1204 which recaps the previously received offer.

The questions provided in the survey 1200 are intended to provide information about why the consumer 110 did not accept a merchant's offer. For example, in the illustrated embodiment, the survey asks the consumer 110 to fill in the following information: (1) if you are not currently interested in the specified product type, please enter the desired product type (block 1206); (2) if the product was too expensive, please enter your maximum purchase price (block 1208); (3) if the store was too far away, please enter your maximum travel distance (block 1210); (4) if you desired a different brand, please specify brand preference (block 1212); (5) if you desired a different model, please specify model number (block 1214); and (6) please enter any other reasons for not accepting the offer (block 1216). Completing these boxes can provide the mobile commence system 500 and the merchant an opportunity to further target offers or discounts. It should be noted that the consume 110 may not need to fill out all of the information boxes. Failure to complete certain the boxes, however, may, in some embodiments, prevent the merchant from providing modified offers to the consumer 110. Further, in some embodiments, the product survey 500 has an advertisement section 1018 that displays one or more targeted advertisements to the consumer 110 based on already known information including, but not limited to, the consumer's previous purchasing history, profile information, and/or current location.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A computer-implemented method comprising:
receiving location information for a consumer's mobile device;
using the location information to determine the consumer's location relative to a merchant;
providing an offer to the consumer's mobile device based at least partially on the consumer's location relative to the merchant;
determining that the consumer lacks interest in the offer; and
communicating with the consumer's mobile device about the offer based at least partially on the determining that the consumer lacks interest in the offer.

2. The computer-implemented method of claim 1, wherein communicating further with the consumer's mobile device about the offer comprises:
providing a survey to the consumer's mobile device, the survey comprising one or more questions inquiring about the consumer's reaction to the offer.

3. The computer-implemented method of claim 2, wherein communicating further with the consumer's mobile device about the offer further comprises:
providing a modified offer to the consumer's mobile device based at least partially on a response to the survey.

4. The computer-implemented method of claim 2, wherein the one or more questions comprise one or more questions inquiring about why the consumer lacks interest in the offer.

5. The computer-implemented method of claim 1, wherein communicating further with the consumer's mobile device about the offer comprises:
providing the consumer's mobile device with a modified offer related to the first offer.

6. The computer-implemented method of claim 1, wherein determining that the consumer lacks interest in the offer comprises:
using the location information to determine that the consumer is leaving the merchant.

7. The computer-implemented method of claim 1, wherein determining that the consumer lacks interest in the offer comprises:
determining that the consumer has not accepted the offer after a predefined period of time.

8. The computer-implemented method of claim 1, wherein determining that the consumer lacks interest in the offer comprises:
receiving from the consumer's mobile device an affirmative rejection of the offer.

9. The computer-implemented method of claim 1, wherein determining that the consumer lacks interest in the offer comprises:
determining that the consumer purchased a competing product competitive with a product associated with the offer.

10. The computer-implemented method of claim 1, wherein determining that the consumer lacks interest in the offer comprises:
identifying a trend in the consumer's transaction history.

11. The computer-implemented method of claim 1, further comprising:
receiving one or more purchase thresholds specified by the consumer; and
providing the offer to the consumer's mobile device based at least partially on the one or more purchase thresholds.

12. The computer-implemented method of claim 11, wherein the one or more purchase thresholds comprises a maximum price.

13. The computer-implemented method of claim 11, wherein the one or more purchase thresholds comprises a maximum distance from the consumer's location.

14. The computer-implemented method of claim 1, wherein receiving location information for the consumer's mobile device comprises receiving information about interaction with the consumer's mobile device and a sensor or transceiver located proximate the merchant.

15. The computer-implemented method of claim 1, wherein receiving location information for the consumer's mobile device comprises receiving location information from a global positioning system.

16. An apparatus comprising:
a positioning system configured for determine location information for a consumer's mobile device;
a computer system configured to use the location information to determine the consumer's location relative to a merchant;
a computer system configured to provide an offer to the consumer's mobile device based at least partially on the consumer's location relative to the merchant;
a computer system configured to determine that the consumer lacks interest in the offer; and
a communication system configured to communicate with the consumer's mobile device about the offer based at least partially on the determining that the consumer lacks interest in the offer.

17. The apparatus of claim 16, wherein the computer system is configured to determine that the consumer lacks interest in the offer is configured to determine that the consumer lacks interest in the offer based at least in part on the location information.

18. An apparatus comprising:
a communication interface configured to receive information from a mobile device; and
a processor configured to:
determine that a consumer associated with the mobile device lacks interest in an offer provided by the merchant, the determination based at least partially on the information received from the mobile device; and
use the communication interface to communicate with the mobile device about the offer based at least partially on the determination that the consumer lacks interest in the offer.

19. The apparatus of claim 18, wherein the processor is configured to use the communication interface to communicate with the mobile device about the offer by:
providing a modified offer to the consumer's mobile device based at least partially on the determination that the consumer lacks interest in the offer, wherein the modified offer is related to the first offer.

20. The apparatus of claim 18, wherein the processor is configured to use the communication interface to communicate with the mobile device about the offer by:
providing a survey to the consumer's mobile device, the survey comprising one or more questions inquiring about the consumer's reaction to the offer.

21. The apparatus of claim 20, wherein the processor is configured to use the communication interface to communicate with the mobile device about the offer by:
providing a modified offer to the consumer's mobile device based at least partially on a response to the survey.

22. The apparatus of claim 20, wherein the one or more questions comprise one or more questions inquiring about why the consumer lacks interest in the offer.

23. The apparatus of claim 18, wherein the information received from the mobile device comprises location information about a current location of the mobile device, and wherein the processor is configured to use the location information to determine that the consumer is leaving the merchant.

24. The apparatus of claim 18, wherein the information received from the mobile device comprises one or more shopping specifications specified by the consumer, and wherein the processor is configured to provide the offer to the consumer's mobile device based at least partially on the one or more shopping specifications.

25. An apparatus comprising:
a memory comprising financial transaction information stored therein for a plurality of consumers;
a positioning system configured to receive location information about a mobile device associated with a consumer of the plurality of consumers;
a communication device configured to communicate with the mobile device; and
a processor communicably coupled to the communication device, the positioning system, and the memory and configured to:
determine from the financial transaction information and the location information a percentage of consumer visits to a merchant that are associated with a transaction; and
provide information to the mobile device or the merchant based at least in part on the percentage of consumer visits to the merchant that are associated with a transaction.

26. The apparatus of claim 25, wherein the processor is configured to:
provide a survey to the mobile device based at least in part on the percentage of consumer visits to the merchant that are associated with a transaction.

27. The apparatus of claim 26, wherein the processor is configured to:
use the communication device to receive survey results from the mobile device and provide the survey results to the merchant.

28. The apparatus of claim 25, wherein the processor is configured to:
provide an offer from the merchant to the mobile device based at least in part on the percentage of consumer visits to the merchant that are associated with a transaction.

29. The apparatus of claim 25, wherein the processor is configured to provide information to the mobile device or the merchant based on whether the percentage is beyond a predefined threshold value.

30. An apparatus comprising:
a memory;
a communication device; and
a processor operatively coupled to the memory and the communication device, wherein the processor is configured to execute non-transitory computer-readable program code to:
receive information related to a physical location of a consumer;
access consumer transaction information from the consumer's account at a financial institution;
determine an offer for the consumer based at least in part on the physical location of the consumer and the consumer transaction information from the consumer's account at the financial institution; and
provide the consumer the offer on a consumer mobile device.

31. The system of claim 30, wherein the processor is further configured to receive purchase thresholds from the consumer and determine an offer for the consumer based at least in part on the purchase thresholds received from the consumer.

32. A computer program product for a mobile commerce system, the computer program product comprising at least one non-transitory computer-readable medium having computer-executable program code portions embodied therein, the computer-executable program code portions comprising:
an executable portion configured for receiving information related to a physical location of a consumer;
an executable portion configured for accessing consumer transaction information from the consumer's account at a financial institution;
an executable portion configured for determining an offer for the consumer based at least in part on the physical location of the consumer and the consumer transaction information from the consumer's account at the financial institution; and
an executable portion configured for providing the consumer the offer on a consumer mobile device.
